(19) United States
(12) Patent Application Publication
(10) Pub. No.: US 2009/0260074 A1
(43) Pub. Date: Oct. 15, 2009

(54) SYSTEM AND METHOD FOR APPLICATION LEVEL ACCESS TO VIRTUAL SERVER ENVIRONMENTS

(75) Inventor: Kristof De Spiegeleer, Knokke-Heist (BE)

Correspondence Address: DLA Piper LLP (US) / Sun Microsystems, Inc., 2000 University Avenue, East Palo Alto, CA, 94303, US

(73) Assignee: Qlayer NV, Lochristi (BE)

(21) Appl. No.: 12/420,729

(22) Filed: Apr. 8, 2009

Related U.S. Application Data
(60) Provisional application No. 61/043,752, filed on Apr. 10, 2008.

(51) Int. Cl. G06F 21/00; G06F 15/16

(52) U.S. Cl. 726/15; 709/228

(57) ABSTRACT

An application level virtual private network (VPN) that provides access for individual applications running on a client computer to physical or virtual servers running in a datacenter is provided. The access connection is secure, automatically setup and does not require changing the network configuration of the client computer. The application running of a client computer, such as a keyboard-video-mouse (KVM), is automatically launched with a single click from the user.

### PRIORITY CLAIM/RELATED APPLICATIONS

This application claims the benefit under 35 USC 119(e) and priority under 35 USC 120 to U.S. Provisional Patent Application Ser. No. 61/043,752, filed on Apr. 10, 2008 and entitled “Application Level VPN for Access to Virtual Server Environments Using KVM and Other Applications” which is incorporated herein by reference.

### FIELD

The disclosure relates to a system and method for providing secure access to a computer system and in particular to a system and method for providing secure access in a virtual computer environment.

### BACKGROUND

A well known virtual private network (VPN) is required to provide remote secure access to physical and/or virtual servers in a datacenter. When a VPN is used, a tunnel is set up with encrypted communication between the client, which is a remote computer outside the datacenter, and a VPN server in the datacenter. The tunnel is used to provide secure communications between the client and one or more servers in the datacenters. The tunnel may be used to connect to the servers with various applications, e.g. for the purpose of managing said servers or for the purpose of using software running on the servers. For example, the various applications may include, but are not limited to, Telnet clients, secure shell (SSH) clients, SCP (secure copy) clients, virtual network computing (VNC) clients, RDP (remote desktop) clients and other applications.

One specific situation exists where a service provider manages servers for customers and the service provider needs to provide access for the customers to said servers. The service provider may typically provide a VPN account that the customer can use to set up a tunnel to the datacenter. The tunnel may provide access to a network in the datacenter or a private LAN or a VLAN and the network, LAN or VLAN may provide access to said servers of the customer.

It is clear to those skilled in the art that there are various drawbacks associated with the scenario described above. One drawback is the fact that a VPN connection changes network configuration on the client such as the IP address, gateway etc and those changes to the network configurations on the client may cause other applications to stop functioning or to loose network connectivity. Another drawback is the fact that a VPN tunnel provides full access to a network, without any control over the application that will be used on the client to connect to the network in the datacenter and the VPN tunnel essentially makes the client computer part of the network in the datacenter. Thus, additional appliances (e.g. firewalls) are required to limit the connectivity between the client and the network in the datacenter for security purposes.

The above drawbacks are especially true for service providers. In particular, a service provider may want to provide its customers with limited connectivity to a datacenter environment for the sole purpose of performing a limited set of tasks. Thus, a VPN tunnel may be too complex to set up, and may not be sufficiently selective in the number of tasks that can be performed from a client on a datacenter environment, such as for example a set of physical or virtual servers. Due to this problem, a service provider may decide not to offer VPN connectivity to its customers and provide web based control panels instead. However, the web based control panels do not allow existing applications to be used, such as for example SSH clients, remote desktop clients and other existing applications.

Thus, it is desirable to provide the benefits of a secure connection for applications to a datacenter without the drawbacks of a VPN connection that allows the usage of existing applications to remotely connect to, for example, virtual or physical servers located in a datacenter and so that applications that can be used can be limited to a specified list of allowed applications. These benefits are provided by a system and method for application level VPN access to virtual server environments using KVM and other applications and it is to this end that the disclosure is directed.

### BRIEF DESCRIPTION OF THE DRAWINGS

FIG. 1 illustrates an example of a first embodiment of an implementation of a secure system for application level access to virtual server environments; and

FIG. 2 illustrates an example of another embodiment of an implementation of a secure system for application level access to virtual server environments.

### DETAILED DESCRIPTION OF ONE OR MORE EMBODIMENTS

The disclosure is particularly applicable for access to a virtual server in a datacenter using an application and it is in this context that the disclosure will be described. It will be appreciated, however, that the system and method has greater utility since it can be used to allow various different local applications to securely access a remote computer and the system can be used to access various different types of remote computers that may or may not be housed in a datacenter.

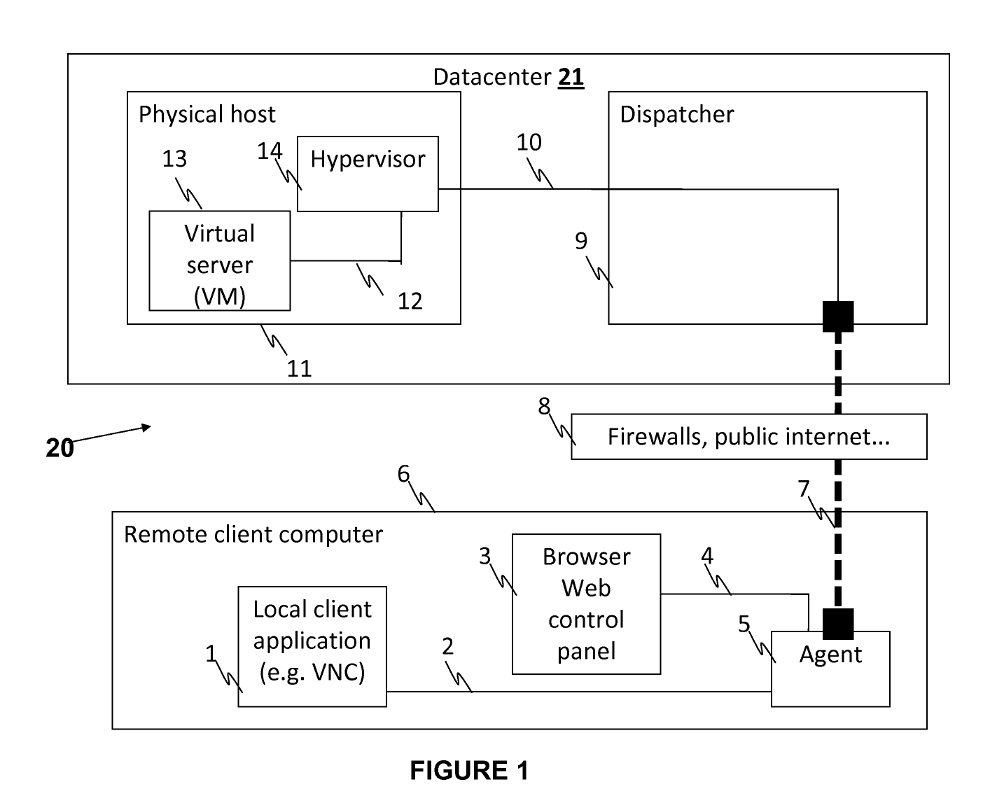

FIG. 1 illustrates an example of a first embodiment of an implementation of a secure system 20 for application level access to virtual server environments. The system may include a datacenter 21 and a remote computer 6 that are capable of connecting to each other over a link 8 that may be a wired or wireless link wherein the link may have firewalls and other security devices that make it more difficult for the remote computer 6 and the datacenter to communicate. Examples of the wired link may be, for example, the Internet, WAN, LAN, Ethernet, etc. and examples of the wireless link may be a cellular network, wireless network, a phone network, etc. The datacenter 21 may be a facility or location that houses one or more computing devices, such as a physical server computer, a virtual server computer, an appliance or a virtual appliance, each of which has well known components that are not described herein. The remote computer 6 may be a processing unit based device with sufficient processing power, memory and connectivity to execute an application 1 and an agent 5 and connect and interact with the datacenter 21. For example, the remote computer may be a personal computer.

The computer 6 may further comprise the application 1 that, in one embodiment, is a piece of software with a plurality of lines of computer code that may be executed by a processing unit of the computer 6 and has the function of establishing a session with the datacenter 21 in order to manage the devices in the datacenter owned by an entity or to use software running on the devices of the datacenter. The application 1 may be, for example, a Telnet client, a secure shell (SSH) client, an SCP (secure copy) client, a virtual network computing (VNC) client, an RDP (remote desktop) client, a Citrix application and other applications that use a known protocol to communicate with a device in the datacenter. The computer 6 may further comprise a connection 2 to the agent 5 that can be controlled over a link 4 using a control panel 3 that may be implemented in one embodiment in a web browser being executed by the computer 6. When the application desires to access the devices in the datacenter 21 (or the user requests access to a device in the datacenter using the control panels 3), it can establish a connection with the agent 5 that, among other things, establishes a secure connection to the datacenter, establishes a particular session with the datacenter (such as, for example, a Telnet session, a secure shell (SSH) session, an SCP (secure copy) session, a virtual network computing (VNC) session, an RDP (remote desktop) session or other sessions) and manages the data between the application 1 and the datacenter 21.

In one implementation, the agent 5 is running as a software application on the computer 6 of the user and the agent has the ability to setup a secure connection, e.g. using SSL, to a device in the datacenter 21. The agent also may act as a local proxy server for various protocols such as Telenet, SSH, etc. This means that a client application running on the same computer can connect to this agent using the localhost IP address 127.0.0.1.

The datacenter 21 may further comprise a dispatcher 9 (implemented in one embodiment as a plurality of lines of computer code executed on a server computer in the datacenter, but also can be implemented as a computer with microcode) that can establish a connection with the agent of the computer and then negotiate a secure communications protocol (such as a virtual private network) with the agent (without user involvement or application involvement). The dispatcher 9 has the capability to terminate a secure tunnel, e.g. using SSL. The dispatcher also can proxy a connection to another server in the datacenter. The dispatcher can be implemented using existing software such as Apache.

The datacenter may also have a link 10 to a host 11 in the datacenter (which may be one of the devices described above of the datacenter) that allows the application 1 in the computer 6, once the secure communication channel is established, to communicate and interact with either the host 11 directly when certain sessions are being executed or with a virtual server 13 so that an application level secure channel is used.

The system 20 shown in FIG. 1 allows a user of the computer 6 to get secure remote access to a device in the datacenter 21. The user uses the computer which is outside the datacenter 21 since a secure connection will be set up between an application 1 on the computer (e.g. an SSH client application) and the device in the datacenter. The connection may be setup over the link 8. The user uses the application 1 to get access to the device in the datacenter, e.g. through an SSH session which allows command line access to the device, or through a VNC session which allows access via a graphical user interface to the device in the datacenter.

For security reasons, the application 1 will not be connected to the device in the datacenter directly. To achieve this, the application 1 makes a connection to the agent 5, running locally on the same computer and the agent will set up a secure tunnel 7 over the link 8 to the dispatcher 9 located in the datacenter. In a preferred embodiment, SSL is used for the secure tunnel between the agent and the dispatcher, but other security protocols may be used. The dispatcher 9 terminates the secure tunnel and it will proxy the connection to the host 11 or to the virtual server 13 directly. The host 11 is the physical server in the datacenter on which the virtual server is running.

In case of a KVM session, the secure connection is terminated on a port of the host 11 on which the hypervisor 14 is listening. In one implementation, the hypervisor is a piece of software (with a plurality of lines of computer code) that, as is known in the computer art, is running on the host 11 to allow the virtual servers to exist on top of the host. The hypervisor 14 will expose the KVM session on said port. A KVM session (keyboard video mouse) provides remote access to the console of the virtual server which means that, for example, during the boot process of the virtual server, the whole boot process will be shown in the KVM session. The KVM session is similar to the direct output to the screen of a non-virtual server. In the case of other types of sessions (as described above), the connection is made directly to a port of the virtual server. The end-result is that the application 1 running on the remote computer 6 has a connection to the device in the datacenter 21, but without the need to expose the device in the datacenter to the internet directly.

In one method for connecting to the device in the datacenter, the connection may be started by the user such as from a web application running in the browser 3 on the computer. This web application may show a list of virtual servers/device in the datacenter to which the user has access permissions. The user may select a device from the list and selects the desired type of connection (e.g. KVM, Telnet, SSH . . . ). The user then clicks on a button “connect”. This web application will now communicate with the agent 5 running on the computer and the agent will setup the secure connection and it will launch the local application.

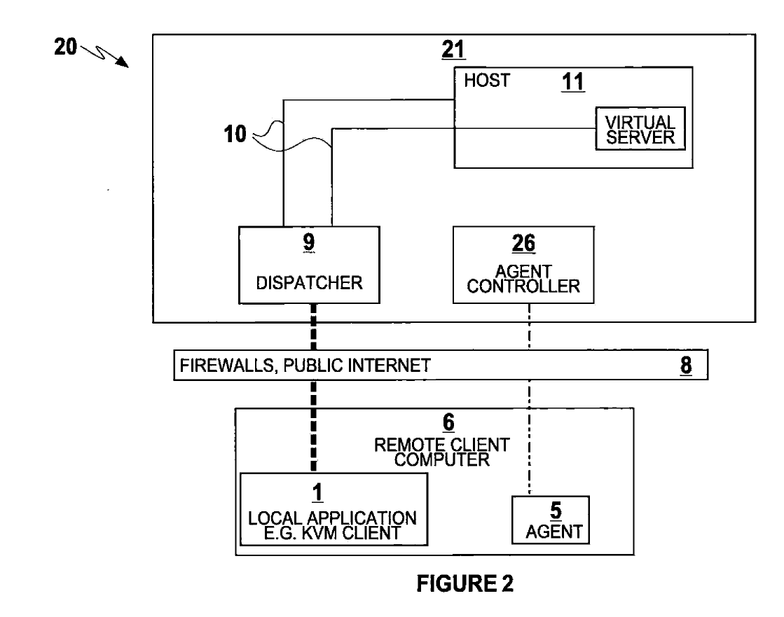

FIG. 2 illustrates an example of another embodiment of an implementation of a secure system 20 for application level access to virtual server environments. Like reference numbers in FIG. 2 refer to like elements in FIG. 1 and they operate in the same manner as described elsewhere and the description of these elements is not repeated for this figure. In this embodiment, the datacenter 21 may further comprise an agent controller 26 that interacts with the agent of the computer to set-up the secure communications and then the session is passed onto the dispatcher as before that provides the same access to the host 11 or the virtual server 13 as described above.

In this embodiment shown in FIG. 2, the computer 6 runs the agent 5 in the background. The agent may be triggered to launch a specific local application (for example a Telnet client) when certain triggers occur. Once triggered, the agent 5 will automatically set up a secure tunnel from the computer 6 to a specific IP address in the datacenter 21. The tunnel may be implemented using SSL or any other means of encryption and the tunnel may use a certificate to authenticate the computer 6. In one implementation, the tunnel may connect to port 80 or port 443 in order to traverse firewalls that block traffic on other ports. The agent 5 may automatically close the tunnel once it is no longer required, e.g. when the local application is closed. The tunnel will be terminated by the dispatcher 9. The dispatcher 9 has connectivity to the devices (e.g. virtual or physical servers) to which that the end-user needs access. The connectivity over the link 10 may be, for example, a private network, a management network, an OOB network (out of band network) or any other type of connectivity.

In one implementation using the second embodiment shown in FIG. 2, the dispatcher 9 will proxy the connection to the final device, depending on the type of application and type of device as follows:
if the device is a physical server, then the connection will be proxied directly to the physical server
if the device is a virtual server and the application is a KVM client, then the connection will be proxied to the physical host of the virtual server, the host will connect to the KVM session of the virtual server
if the device is a virtual server and the application is not a KVM client, then the connection will be proxied directly to the virtual server.

In a second implementation using the second embodiment shown in FIG. 2, when the end-user connects to a virtual server, the dispatcher 9 will always connect to the physical host 11 of the virtual server and the physical host 11 will connect to the virtual server 13. This implementation eliminates the need of a direct connection between the dispatcher 9 and the virtual server 13. In the second implementation, the connection may comprise connecting to a NIC (network interface) of the physical host and/or a connection between the physical host and the virtual NIC of the virtual server.

In a third implementation using the second embodiment shown in FIG. 2, the application 1 is launched by the end-user from a web based interface wherein the interface may be, for example, a web based control panel of a service provider. The application 1 is automatically launched on the local computer of the end-user and automatically connected to the applicable device in the datacenter such as for example a virtual or physical server. For example the customer of a service provider may login on a web interface to see a list of his virtual and physical servers. The customer may select a server by clicking it. The customer may see a list of applications that can be used to manage the specific selected server. The customer may select for example “KVM client”. A KVM application will be launched automatically within a few seconds on the local computer of the customer. Note that this is not a web application but a local application. In case the local computer runs the Windows operating system, said application would be a Windows application. The KVM application will automatically be connected to the server that the customer selected. The customer can immediately use the application to manage said server.

In an example of a use case of the system and method for application level secure access to device in the datacenter, the following processes may occur:

1. Customer logs in on a web based control panel of a service provider with its own login and password

2. The web based interface shows a list of devices (e.g. virtual servers) to which the customer has access rights

3. The customer selects a device by clicking the device in the list

4. The web based interface shows a list of applications that can be used to connect to the device

5. The customer selects an application by clicking the application name in the list (e.g. KVM client, SSH client . . . )

6. The web based control panels communicates (directly or indirectly) with the agent, running in the background on the local computer

7. The agent launches the applicable application on the local computer

8. The application will automatically be connected to the agent, which acts as a proxy server (IP address 127.0.0.1) on the local computer

9. The agent will set up a secure tunnel (e.g. using SSL) to a dispatcher in the datacenter

10. From the agent the connection is setup over the secure tunnel to the dispatcher in the datacenter

11. From the dispatcher the connection is made to the virtual server or to the host of the virtual server

While the foregoing has been with reference to a particular embodiment of the invention, it will be appreciated by those skilled in the art that changes in this embodiment may be made without departing from the principles and spirit of the invention, the scope of which is defined by the appended claims.

1. A method to set up a secure remote connection between an application running on a computer and a device running in a datacenter, the method comprising:
requesting a session, at a computer, to a device in the datacenter;
executing an application on the computer;
associating the application to an agent running locally on the computer wherein the agent acts as a proxy to the application;
setting up, by the agent, a secure connection with a dispatcher located in the remote data center;
proxying, at the dispatcher, the secure connection to the device in the datacenter; and
initiating, in the application, a session to interact securely with the device in the datacenter over the application level secure connection.

2. The method of claim 1, wherein initiating the session further comprises initiating a keyboard video mouse (KVM) session and wherein proxying the secure connection further comprises proxying the secure connection to a host of a virtual server to provide access to a KVM session of the virtual server.

3. The method of claim 1, wherein initiating the session further comprises initiating a Telnet session and wherein proxying the secure connection further comprises proxying the secure connection directly to a virtual server.

4. The method of claim 1, wherein initiating the session further comprises initiating a secure shell (SSH) session and wherein proxying the secure connection further comprises proxying the secure connection directly to a virtual server.

5. The method of claim 1, wherein initiating the session further comprises initiating a remote desktop (RDP) session and wherein proxying the secure connection further comprises proxying the secure connection directly to a virtual server.

6. The method of 1 further comprising executing the agent in the background.

7. The method of claim 1, wherein setting up the secure connection further comprising setting up a virtual private network between the agent and the dispatcher.

8. The method of claim 1, wherein requesting the session further comprises selecting, by a user of the computer, a device of the datacenter and an application to be used to connect to the device of the datacenter.

9. A system to set up a secure remote connection between an application running on a computer and a device running in a datacenter, comprising:
a computer system executing an application;
one or more devices in a datacenter;
an agent, being executed by the computer system, that establishes a connection with the application and acts a proxy for the application;
a dispatcher in the datacenter, the dispatcher capable of setting up a secure connection with the agent of the computer system, the dispatcher being a proxy for the one or more devices in the datacenter; and
wherein a secure session between a device in the datacenter and the application is established to allow the application and the device to interact securely.

10. The system of claim 9, wherein the client application initiates a keyboard video mouse (KVM) session and wherein the dispatcher proxies the secure connection to a host of a virtual server to provide access to a KVM session of the virtual server.

11. The system of claim 9, wherein the client application initiates a Telnet session and wherein the dispatcher proxies the secure connection directly to a virtual server.

12. The system of claim 9, wherein the client application initiates a secure shell (SSH) session and wherein the dispatcher proxies the secure connection directly to a virtual server.

13. The system of claim 9, wherein the client application initiates a remote desktop (RDP) session and wherein the dispatcher proxies the secure connection directly to a virtual server.

14. The system of 9, wherein the agent executes in the background of the computer.

15. The system of claim 9, wherein the agent sets up a virtual private network between the agent and the dispatcher.

16. The system of claim 9, wherein each of the one or more devices in the datacenter further comprise one of a physical server computer, a virtual server computer, an appliance and a virtual appliance.

17. The system of claim 9, wherein the computer system further comprises a user interface in which a user of the computer selects a device of the datacenter and an application to connect to the device of the datacenter wherein a secure session between the selected device in the datacenter and the application is established to allow the application and device to interact securely.
